(19) United States
(12) Patent Application Publication
(10) Pub. No.: US 2009/0037300 A1
(43) Pub. Date: Feb. 5, 2009

(54) Systems, Methods, and Computer Readable Storage Media for Tracking Assets

(76) Inventor: Michael Steven Abrams, Suwanee, GA (US)

Correspondence Address: HOPE BALDAUFF HARTMAN, LLC, 1720 PEACHTREE STREET, N.W, SUITE 1010, ATLANTA, GA, 30309, US

(21) Appl. No.: 11/934,478

(22) Filed: Nov. 2, 2007

Related U.S. Application Data
(60) Provisional application No. 60/952,755, filed on Jul. 30, 2007.

(51) Int. Cl. G06Q 10/00; G06F 17/40; G06F 19/00

(52) U.S. Cl. 705/28

(57) ABSTRACT

Systems, methods, and computer readable storage media for tracking assets are disclosed. A system for tracking assets include a processor and memory comprising instructions configured to enable the processor to provide selectable options corresponding to respective premises. After the user selects a premises, then the user is provided with selectable options corresponding to aisles within the premises. The user is then provided with selectable options corresponding to frames along the selected aisle, shelves on a selected frame, and equipment or equipment locations on a selected shelf The user may then view and/or enter information related to a selected piece of equipment.

### CROSS-REFERENCE TO RELATED APPLICATIONS

This patent application claims priority to U.S. provisional application having Ser. No. 60/952,755, entitled “Systems and Methods for Tracking Assets,” filed Jul. 30, 2007 which is hereby incorporated by reference in its entirety.

### TECHNICAL FIELD

This application relates generally to the field of inventory management. More specifically, this application relates to systems and methods for tracking assets.

### BACKGROUND

In order for a business to be successful it must be able to track, manage and maintain its assets. Many companies have thousands of assets that the company needs to track. If the assets are not tracked correctly then large financial losses can occur due to poor asset management. Examples of assets that are tracked are telecommunication equipment. A telecommunication company may have hundreds of thousands of pieces of telecommunication equipment located at respective central offices. Each central office may have many aisles, frames, and shelves where telecommunication equipment may be located. Tracking telecommunication equipment at central offices can be time consuming, expensive, and error prone.

### SUMMARY

Systems, methods, and computer readable storage media for tracking assets are disclosed. Exemplary embodiments of a system for tracking assets include a processor and memory comprising instructions configured to enable the processor to provide selectable options corresponding to respective premises. After the user selects a premises, then the user is provided with selectable options corresponding to floor layout of the applicable premise including aisles within the premises. The user is then provided with selectable options corresponding to frames along the selected aisle, shelves on a selected frame, and equipment or equipment locations on a selected shelf. The user may then view and/or enter information related to a selected piece of equipment.

Other systems, methods, and/or computer readable storage media according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a block diagram illustrating an asset tracking system, in accordance with exemplary embodiments.

FIG. 2 is a schematic diagram illustrating a premises selection window for selecting a premises that houses equipment for which a user wants to view and/or update asset information, in accordance with exemplary embodiments.

FIG. 3 is a schematic diagram illustrating an aisle selection window for selecting an aisle that houses equipment for which a user wants to view and/or update asset information, in accordance with exemplary embodiments.

FIG. 4 is a schematic diagram illustrating a frame selection window for selecting a frame that houses equipment for which a user wants to view and/or update asset information, in accordance with exemplary embodiments.

FIG. 5 is a schematic diagram illustrating a shelf selection window for selecting a shelf that supports equipment for which a user wants to view and/or update asset information, in accordance with exemplary embodiments.

FIG. 6 is a schematic diagram illustrating an equipment selection window for selecting equipment for which a user wants to view and/or update asset information, in accordance with exemplary embodiments.

FIG. 7 is a flow chart illustrating a data synchronization method, in accordance with exemplary embodiments.

FIG. 8 is a flow chart illustrating an asset tracking method, in accordance with exemplary embodiments.

FIG. 9 is a flow chart illustrating for an initial inventory method, in accordance with exemplary embodiments.

FIG. 10 is a flow chart illustrating an incremental inventory method, in accordance with exemplary embodiments.

FIG. 11 is a block diagram illustrating an asset tracking device, in accordance with exemplary embodiments.

FIG. 12 is a block diagram illustrating an asset tracking server, in accordance with exemplary embodiments.

### DETAILED DESCRIPTION

The following detailed description is directed to methods, systems, and computer-readable media for tracking assets. In the following detailed description, references are made to the accompanying drawings that form a part hereof, and which are shown by way of exemplary embodiments and implementations. According to exemplary embodiments, an asset tracking system reduces the number of manual procedures used during an inventory process. This reduction in manual procedures increases data accuracy and integrity and reduces the time required to re-inventory telecommunication assets at various asset locations.

Note that although the subject matter presented herein has been described in conjunction with one or more particular embodiments and implementations, it is to be understood that the embodiments are not necessarily limited to the specific structure, configuration, or functionality described herein. Rather, the specific structure, configuration, and functionality descried herein are disclosed as examples. Various modifications and changes may be made to the subject matter described herein without following the exemplary embodiments and applications illustrated and described, and without departing from the true spirit and scope of the embodiments.

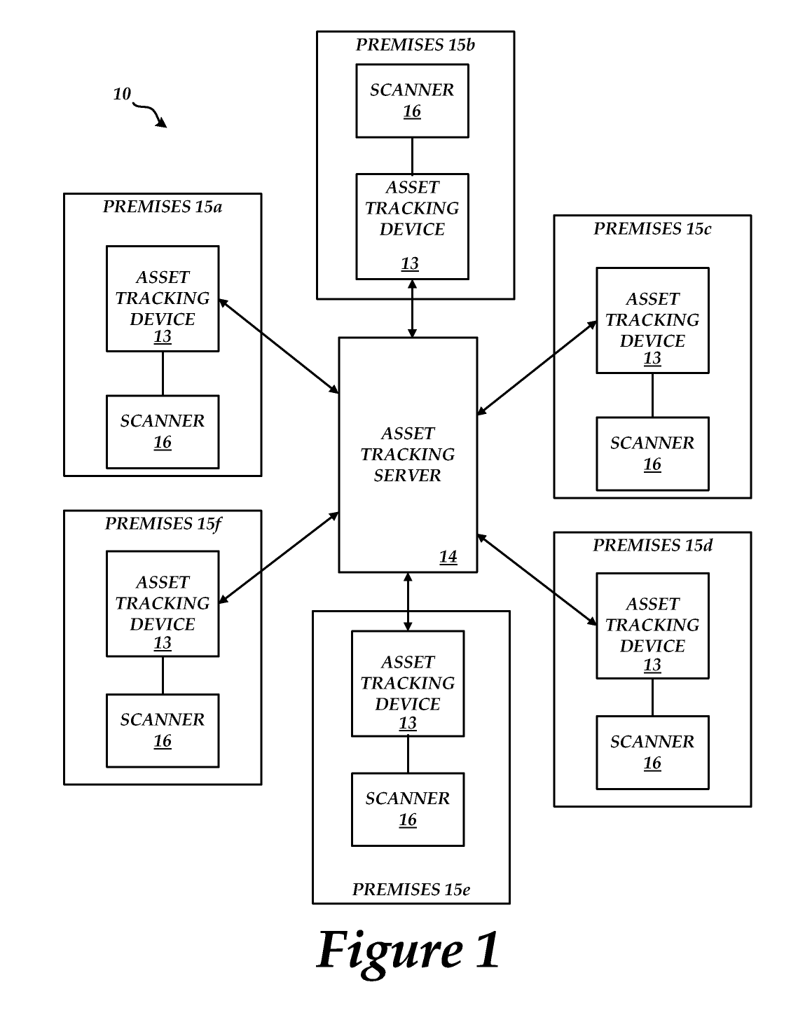

FIG. 1 is a block diagram depicting an asset tracking system 10, in accordance with exemplary embodiments. The asset tracking system 10 includes asset tracking devices 13 and an asset tracking server 14. The asset tracking devices 13 may be used to track assets located at premises 15a-15f. The assets to be tracked may be, for example, telecommunication equipment located at a central office. The asset tracking devices 13 may be, for example, laptop computers and/or tablet PCs that house asset tracking applications and database programs, such as, for example, Microsoft Access™ database program. The asset tracking devices 13 may be coupled to respective barcode scanners 16 for scanning barcodes on assets to be tracked. The asset tracking devices 13 may also be coupled to respective barcode label printers for printing barcodes to be attached to the assets.

According to exemplary embodiments, the asset tracking device 13 enables a user to view, change or read inventory data for a particular time period (e.g., current day, month or year) and/or location (e.g., the premises 15a). The asset tracking device 13 may also be configured to receive and store data for equipment located at a same premises, such as the premises 15a, as the asset tracking device 13. Each of the asset tracking devices 13 may be identified by a common language location identification (CLLI) code corresponding to the premises 15a-15f where the asset tracking device 13 is located. The asset tracking server 14 may include an asset tracking application and a database, such as, for example, an Oracle™ database. The server database includes current and/or archived inventory data for the premises 15a-15f. The asset tracking device 13 and the asset tracking server 14 may have respective databases that are synchronized at regular intervals to update inventory data for the premises 15a-15f.

The asset tracking devices 13 may reside at respective premises, such as the premises 15a-15f, for which asset tracking is desired. The asset tracking devices 13 may enable users to view, add, and update inventory records for the premises 15a-15f. Depending on a desired implementation, a user may be prevented from adding or updating inventory records at a premises other than a premises, such as the premises 15a, where the user is located. A predetermined user name and password may be assigned (e.g., by a manager or system administrator) to users of the asset tracking devices 13 to prevent unauthorized access to asset tracking data in the asset tracking system 10.

According to exemplary embodiments, the asset tracking system 10 uses predetermined identifiers for an entity's equipment. The identifiers may be printed on barcode labels and affixed to respective pieces of equipment. A barcode label may allow equipment information to be retrieved or updated with a single barcode scan. Labels may have features, such as, for example, certain colored stripes (e.g., green) across the top of the labels to allow the user to differentiate them from equipment labels not related to the asset tracking system 10.

Barcode labels may be used to enable the asset tracking system 10 to track asset locations. For example, a user may scan a barcode label affixed to a shelf on which a communication device is or will be installed and then scan the barcode label on the communication device to associate the communication device with the corresponding premises, room, aisle, frame, and/or shelf. Note that the barcode label on the communication device may alternatively be scanned prior to scanning the barcode label on the corresponding shelf.

Various barcode label formats may be used by the asset tracking system 10 depending on whether a label is to be used for “hard-wired” equipment or plug-in equipment. Hard-wired equipment includes, for example, premises location, frames, and shelves. Plug-in equipment, on the other hand, includes, for example, telecommunication devices. Barcode labels for hard-wired and plug-in equipment may include a serial number and a predetermined part number identifier. An exemplary barcode label format for hard-wired equipment (e.g., frames and shelves) may be as follows:

# #-A A# #-A A A A # # # # A

In the above-shown exemplary format, “#” represents a numeral and “A” represents an alphabet character. This format uses sixteen characters with an optional seventeenth character to designate a cabinet side (e.g., front or rear). Dash characters may be used as separators or place holders. Underscore characters may be used for fillers. In a particular implementation, the first two characters (e.g., numerals) are used to identify the floor or room where the equipment is located. The next two characters are used to identify a row, aisle, or line-up. The next two characters are used to identify a bay or frame. The next six characters identify the equipment. The next two characters identify a shelf. The final character identifies whether a cabinet is a front or rear cabinet. A person of ordinary skill in the art would recognize that alternative barcode label formats may also be used.

The asset tracking system 10 may be used for initial inventory tracking, incremental inventory tracking, and/or ongoing maintenance of inventory records. During an initial inventory process completed using the asset tracking system 10, equipment information is scanned, validated, and added to the database. Barcode labels are then printed and affixed to the equipment in accordance with exemplary embodiments.

An incremental inventory process may take place at regular intervals after the initial inventory process is complete. During an incremental inventory process, scanned and validated inventory parts are compared against previously recorded information for a particular location and verified for accuracy. Barcode labels are printed and affixed to new equipment or to equipment with damaged or lost labels.

Ongoing maintenance of inventory records facilitates the execution of an efficient incremental inventory process. According to exemplary embodiments, ongoing maintenance of inventory records includes adding new equipment information and verifying and updating equipment records. Inventory records may be updated due to equipment being added, moved, transferred, or retired. As new equipment is received at one of the premises 15a-15f, the corresponding equipment information may be added to the asset tracking system 10 database to ensure that inventory records are current and ready for the next incremental inventory process.

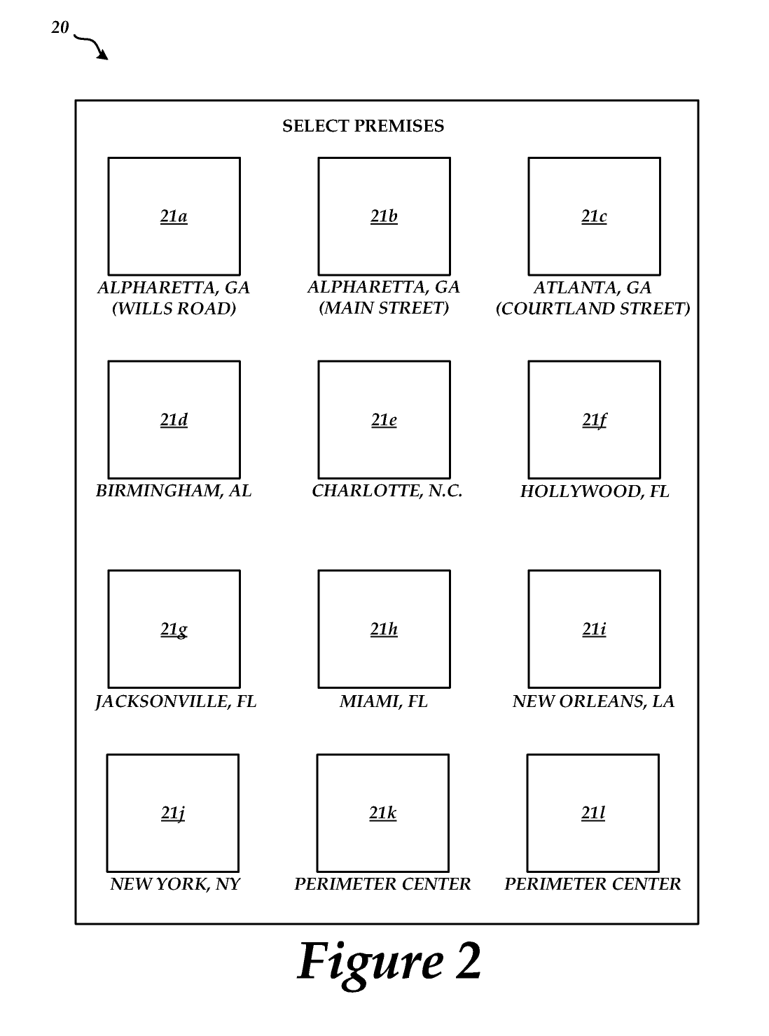

FIGS. 2-6 are schematic diagrams illustrating user interface windows 20, 30, 40, 50, 60, respectively, for enabling a user to track assets, in accordance with exemplary embodiments. The user may make a selection from the user interface windows 20, 30, 40, 50, 60 via a user input device, such as, for example, a mouse, a keyboard, or a touch-screen display. Each of the user interface windows 20, 30, 40, 50, 60 illustrated in FIGS. 2-6, respectively, may be provided by the asset tracking device 13.

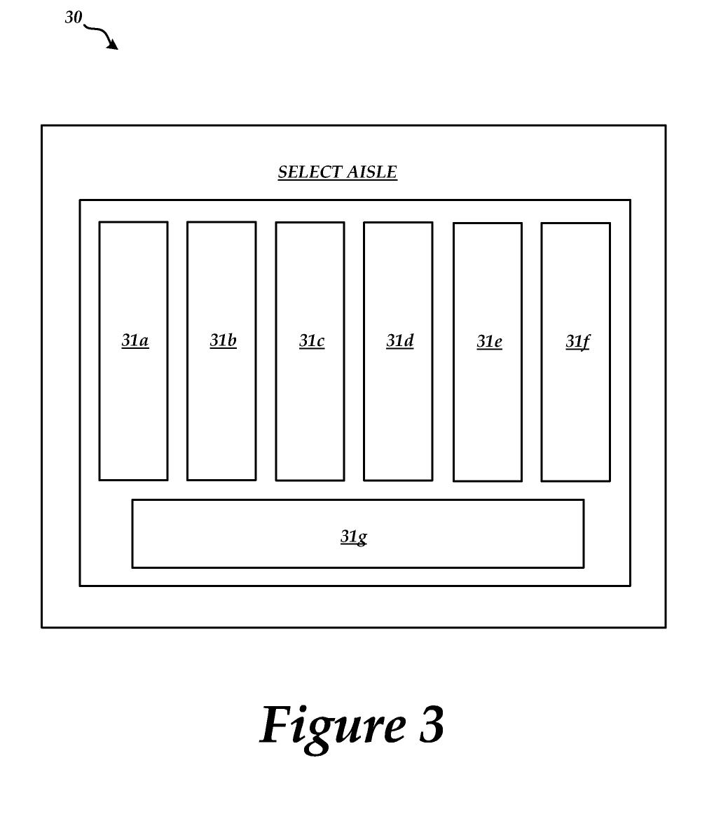

FIG. 2 illustrates a premises selection window 20 for selecting the premises 15a-15f that houses equipment for which a user wants to view and/or update asset information, in accordance with exemplary embodiments. Premises icons 21a-21l corresponding to respective premises, such as the premises 15a-15f, may be displayed in the premises selection window 20. For example, the premises icon 21e corresponds to a premises located in Charlotte, North Carolina, as illustrated in FIG. 2. The premises icons 21a-21l corresponding to premises, such as the premises 15a-15f, to which a user's asset tracking device, such as the asset tracking device 13, is assigned may be highlighted using a particular color, such as, for example, red. A user may view or read information from multiple premises, such as the premises 15a-15f. However, according to one implementation, a user may add or edit asset information for only a premises, such as the premises 15a, corresponding to the location of the asset tracking device 13 being used to add or edit the asset information. Responsive to the user selecting one of the premises icons 21a-21l, the user may be presented with a user interface window for selecting an aisle. For example, the user may be provided with an aisle selection window 30 shown in FIG. 3.

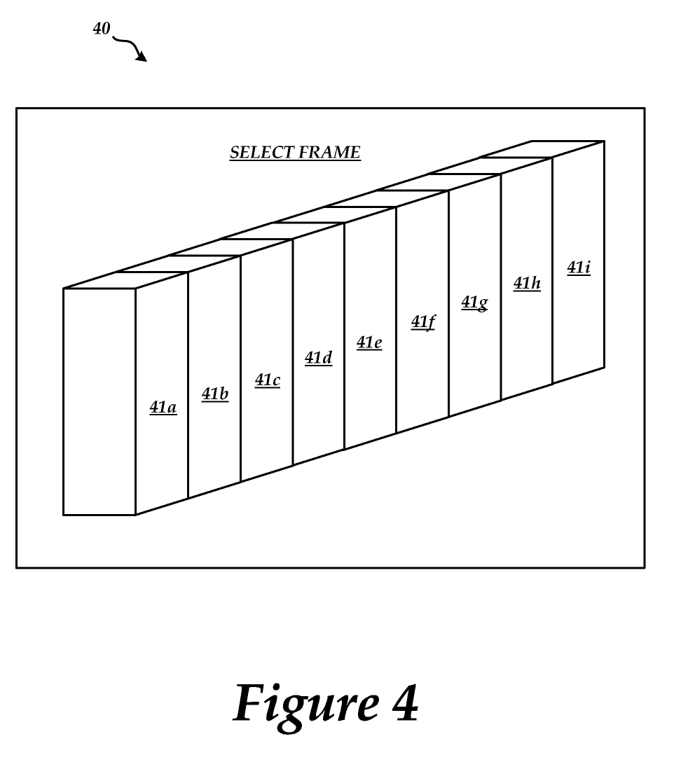

FIG. 3 is a schematic diagram depicting the aisle selection window 30 for selecting an aisle that houses equipment for which a user wants to view and/or update asset information, in accordance with exemplary embodiments. To provide the aisle selection window 30, the asset tracking device 13 may use a customized navigation feature that employs a detailed floor plan layout for each of the premises 15a-15f. This feature allows a user to visually navigate an office, locate a piece of equipment, and access equipment information from the database, according to exemplary embodiments. The aisle selection window 30 may include a diagram illustrating the physical layout of aisles within the premises 15a-15f that the user selected via the premises selection window 20. According to exemplary embodiments, the aisle selection window 30 includes aisle icons 31a-31g representative of the aisles within the premises 15a-15f. Responsive to the user selecting one of the aisle icons 31a-31g corresponding to a desired aisle, the user may be presented with a user interface window for selecting a frame within the selected aisle. For example, the user may be provided with the frame selection window 40 shown in FIG. 4.

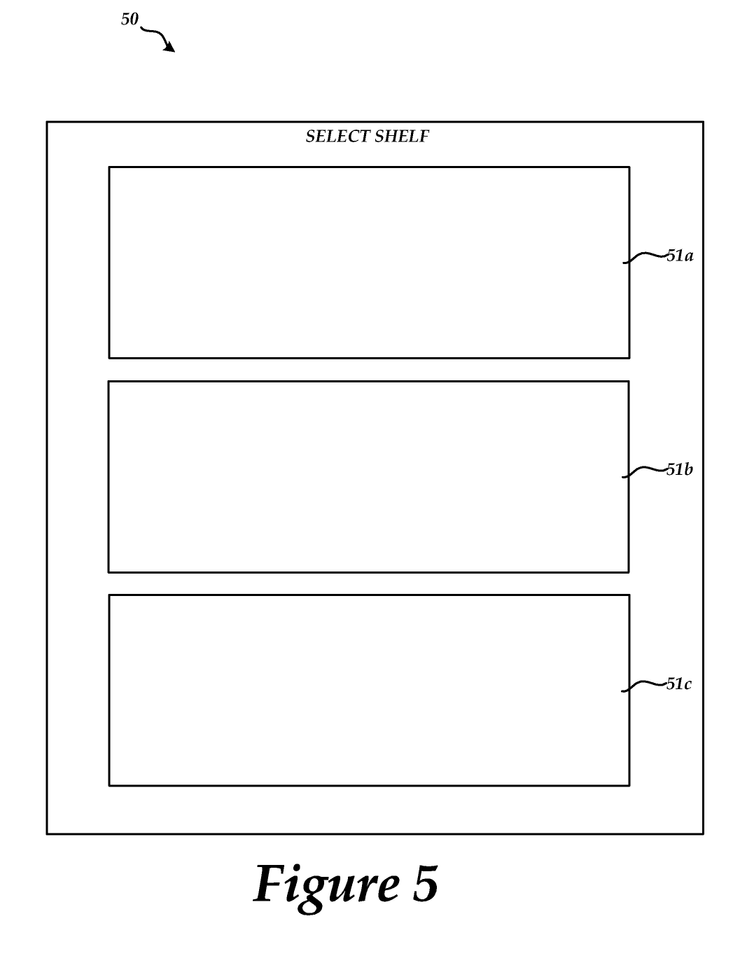

FIG. 4 is a schematic diagram depicting the frame selection window 40 for selecting a frame that houses equipment for which a user wants to view and/or update asset information, in accordance with exemplary embodiments. As used herein, a frame is a unit that houses several shelves that support telecommunication equipment. One or more rows of frames may be set-up along each aisle. The frame selection window 40 may include a diagram illustrating the frames residing in the aisle that the user selected via the aisle selection window 30. According to exemplary embodiments, the frame selection window 40 includes frame icons 41a-41i representative of the frames residing in the aisle selected via the aisle selection window 30. Responsive to the user selecting one of the frame icons 41a-41i corresponding to a desired frame, the user may be presented with a user interface window for selecting a shelf within the selected frame. For example, the user may be provided with the shelf selection window 50 shown in FIG. 5.

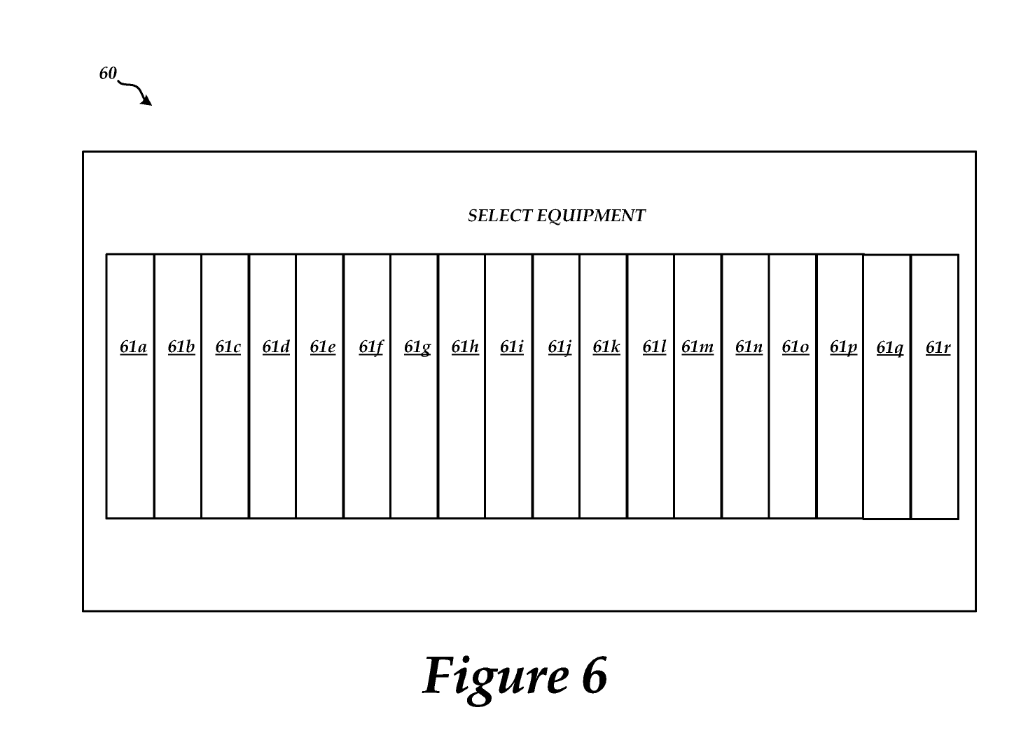

FIG. 5 is a schematic diagram depicting the shelf selection window 50 for selecting a shelf that supports equipment for which a user wants to view and/or update asset information, in accordance with exemplary embodiments. The shelf selection window 50 may include a diagram illustrating the shelf configuration corresponding to the frame that the user selected via the frame selection window 40. According to exemplary embodiments, the shelf selection window includes shelf icons 51a-51c representative of the shelves associated with the frame selected via the frame selection window 40. Responsive to the user selecting one of the shelf icons 51a-51c corresponding to a desired shelf, the user may be presented with a user interface window for selecting equipment on the selected shelf. For example, the user may be provided with the equipment selection window 60 shown in FIG. 6.

FIG. 6 is a schematic diagram depicting the equipment selection window 60 for selecting equipment for which a user wants to view and/or update asset information, in accordance with exemplary embodiments. The equipment selection window 60 may illustrate the configuration of equipment on the selected shelf. According to exemplary embodiments, the equipment selection window 60 includes equipment icons 61a-61r representative of the equipment associated with the shelf selected via the shelf selection window 50. Responsive to the user selecting one of the equipment icons 61a-61r corresponding to the desired equipment, the user may be presented with a user interface window (not shown) that enables the user to view, add, edit, and/or delete information corresponding to the equipment. The information provided by or to a user regarding the equipment corresponding to the selected equipment icon 61a-61r may include, for example, a serial number, a part number, a manufacturer code, a common language equipment identification (CLEI) code, an installation date, and/or a description of the equipment, and/or any further information relevant to the equipment.

The equipment selection window 60 may additionally or alternatively be configured to enable a user to select an equipment location (e.g., a slot on a shelf) for which the user wants to add new equipment. By selecting an equipment location and then entering information about the new equipment being installed, the asset tracking device 13 associates the new equipment with the selected location so that the new equipment can be tracked by the asset tracking system 10.

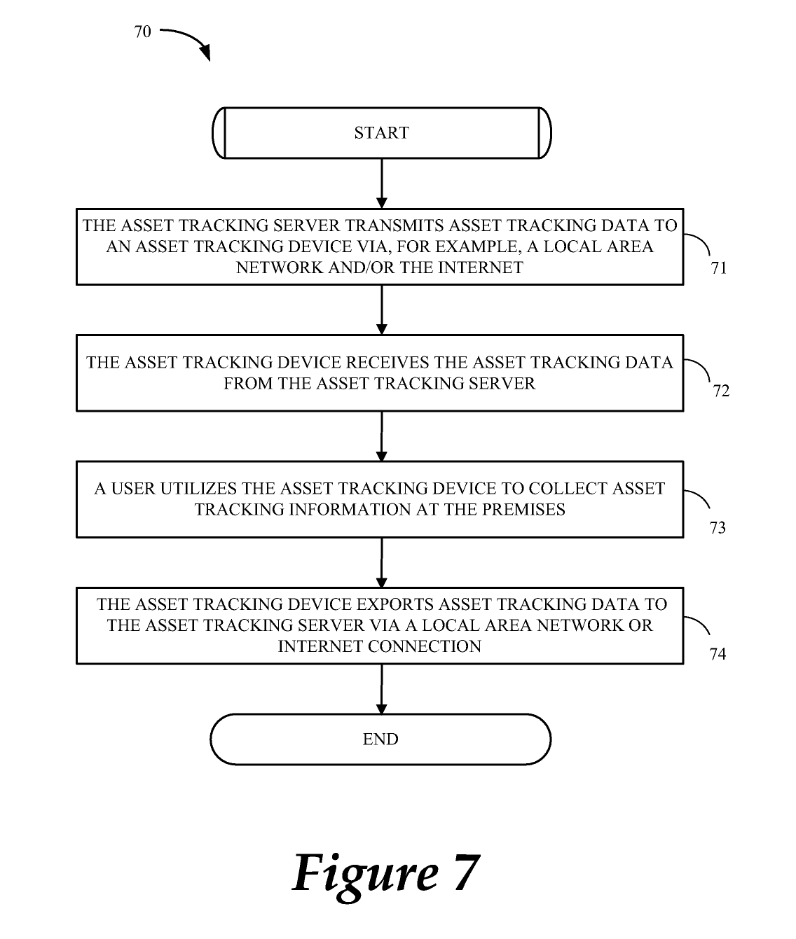

FIG. 7 is a flow chart illustrating a data synchronization method 70, in accordance with exemplary embodiments. According to exemplary embodiments, the databases of the asset tracking device 13 and the asset tracking server 14 are synchronized at regular intervals to update data for some or all of the premises 15a-15f. As indicated in block 71, the asset tracking server 14 transmits asset tracking data to the asset tracking device 13 via, for example, a local area network and/or the Internet. The asset tracking data identifies assets at some or all of the premises 15a-15f and includes data received from other asset tracking devices, such as the asset tracking devices 13. The asset tracking data may identify, for example, telecommunications devices and their corresponding aisle, frame, and shelf at respective premises, such as the premises 15a-15f.

As indicated in block 72, the asset tracking device 13 receives the asset tracking data from the asset tracking server 14. The asset tracking device 13 and/or the asset tracking server 14 may be configured to convert the format of the asset tracking data to a desired format. The format of the asset tracking data may be converted, for example, between a Microsoft Access™ format and an Oracle™ format, depending on the format that the asset tracking device 13 and the asset tracking server 14 use to store asset tracking data. As indicated in block 73, a user utilizes the asset tracking device 13 to collect asset tracking information at the premises 15a-15f The user may, for example, scan barcode labels on existing devices at one of the premises 15a-15f so that asset tracking data may be updated or verified to reflect that the equipment is located at the one corresponding premises 15a-15f. The user may alternatively or additionally enter asset data via other input devices, such as a mouse or keyboard. As indicated in block 74, the asset tracking device 13 exports asset tracking data to the asset tracking server 14 via a local area network or internet connection. Other asset tracking devices, such as the asset tracking devices 13, located at the same or different premises, such as the premises 15a-15f, may also export asset tracking data to the asset tracking server 14.

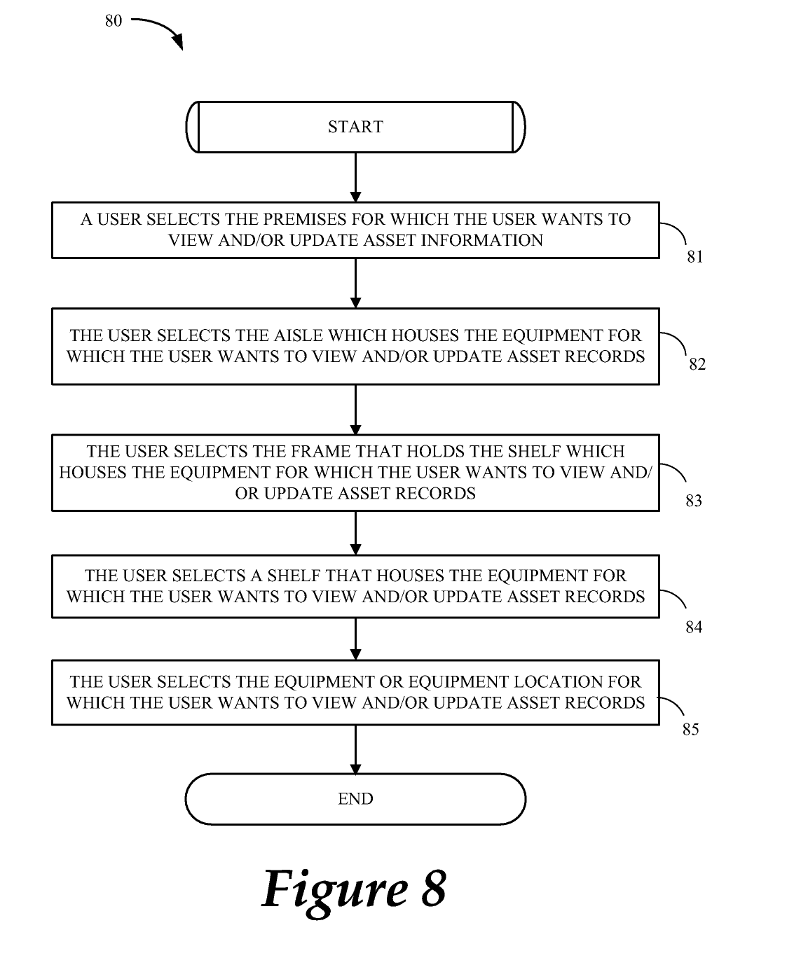

FIG. 8 is a flow chart illustrating an asset tracking method 80, in accordance with exemplary embodiments. As indicated in block 81, a user makes a selection among the premises 15a-15f for which the user wants to view and/or update asset information. The user may select among the premises 15a-15f via, for example, the premises selection window 20 shown in FIG. 2. Responsive to the user selecting one or more of the premises 15a-15f via the premises icons 21a-21l, the user may be presented with a user interface window for selecting an aisle. For example, the user may be provided with the aisle selection window 30 shown in FIG. 3. The aisle selection window 30 includes a diagram illustrating the physical layout of the aisles within a premises, such as the premises 15a that the user has selected via the premises selection window 20.

As indicated in block 82, the user selects the aisle which houses the equipment for which the user wants to view and/or update asset records via the aisle icons 31a-31g of the aisle selection window 30. Responsive to the user selecting one of the aisle icons 31a-31g, the user may be presented with a user interface window for selecting a frame. For example, the user may be provided with the frame selection window 40 shown in FIG. 4. The frame selection window 40 includes a diagram illustrating the frames residing in the aisle the user has selected.

As indicated in block 83, the user selects the frame that holds the shelf which houses the equipment for which the user wants to view and/or update asset records via the frame icons 41a-41i of the frame selection window 40. Responsive to the user selecting one of the frame icons 41a-41i, the user may be presented with a user interface window for selecting a shelf within the selected frame. For example, the user may be provided with the shelf selection window 50 shown in FIG. 5. The shelf selection window 50 may include a diagram illustrating the shelf configuration of the frame the user has selected.

As indicated in block 84, the user selects a shelf that supports the equipment for which the user wants to view and/or update asset records via the shelf icons 51a-51c of the shelf selection window 50. Responsive to the user selecting one of the shelf icons 511-51c, the user may be presented with a user interface window for selecting equipment or an equipment location on the selected shelf. For example, the user may be provided with the equipment selection window 60 shown in FIG. 6. The equipment selection window 60 may illustrate the configuration of equipment or equipment locations on a shelf.

As indicated in block 85, the user selects the equipment or equipment location for which the user wants to view and/or update asset records via the equipment icons 61a-61r. Responsive to the user selecting one of the equipment icons 61a-61r, the user may be presented with a user interface window that enables the user to view, add, edit, and/or delete information corresponding to the selected equipment. For example, the user may add information identifying and/or describing telecommunication equipment that is newly added to the selected frame.

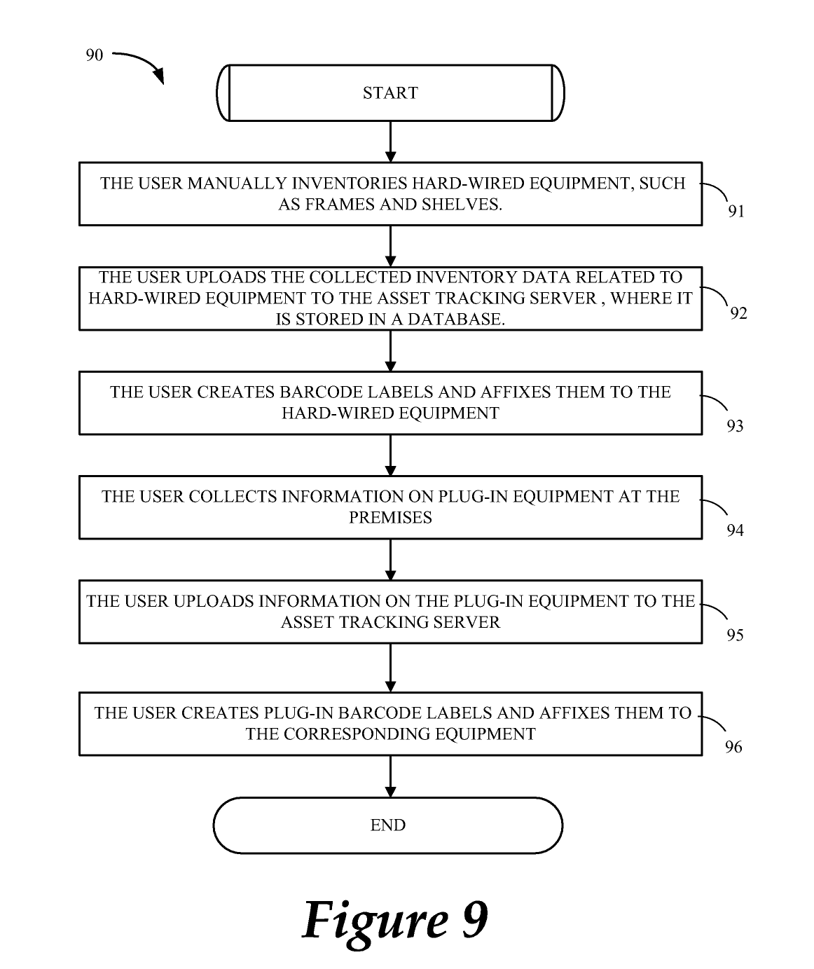

FIG. 9 is a flow chart illustrating an initial inventory method 90, in accordance with exemplary embodiments. According to exemplary embodiments, the initial inventory process is the first inventory process completed using the asset tracking system 10. The initial inventory process involves locating equipment, affixing barcodes to equipment and corresponding frames, and loading inventory information into a database.

As indicated in block 91, the user may manually inventory hard-wired equipment, such as frames and shelves. The purpose of inventorying hard-wired equipment is to collect data records on assets (working and spare inventory). This data is compiled from various sources, such as information physically located on the equipment itself, equipment records, equipment catalogue, and/or equipment files. Data identifying the layout and location of hard-wired equipment may also be gathered. Data gathered about hard-wired equipment may be recorded, for example, in a spreadsheet program, such as Excel™. As indicated in block 92, the user uploads the collected inventory data related to hard-wired equipment to the asset tracking server 14, where it is stored in a database.

After uploading the data related to hard-wired equipment, the user creates barcode labels and affixes them to the hard-wired equipment, as indicated in block 93. Scannable barcode label images may be produced by barcode software and then printed via a barcode printer. After the labels are printed, each barcode label is affixed to corresponding hard-wired equipment, such as, for example, a frame or shelf. These barcode labels may facilitate subsequent inventory processes as well as provide a highly visible, consistent numbering scheme and naming convention for frames and shelves.

After barcodes labels are affixed to corresponding hard-wired equipment the user collects information on equipment, such as plug-in equipment at one or more of the premises 15a-15f, as indicated in block 94. Data collection on plug-in equipment may include the collection of data for both working and spare plug-in equipment. The data collected on the plug-in equipment may include information identifying the equipment, such as, for example, one or more serial numbers or codes, as well as information describing the equipment. The data may be collected by scanning barcodes on the plug-in equipment and/or entering data via a user input device, such as a mouse and/or a keyboard. Location data for the equipment may also be collected either manually or by scanning barcode labels affixed to the respective shelves. The location data may identify, for example, the aisle, frame, and/or shelf corresponding to each piece of equipment.

As indicated in block 95, the user uploads information on the plug-in equipment to the asset tracking server 14. After the information is collected, the user connects the asset tracking device 13 to a docking station and the information is uploaded to the asset tracking server 14. The asset tracking device 13 may be connected to a docking station via a wired or wireless connection. The asset tracking device 13 may alternatively be configured to transmit the plug-in equipment information without using a docking station.

After plug-in data for one or more of the premises 15a-15f has been uploaded, the user creates barcode labels and affixes them to the corresponding equipment, as indicated in block 96. Scannable barcode labels may be produced by a barcode software application and then printed via a barcode label printer. After the barcode labels are printed, each label is affixed to a corresponding piece of equipment.

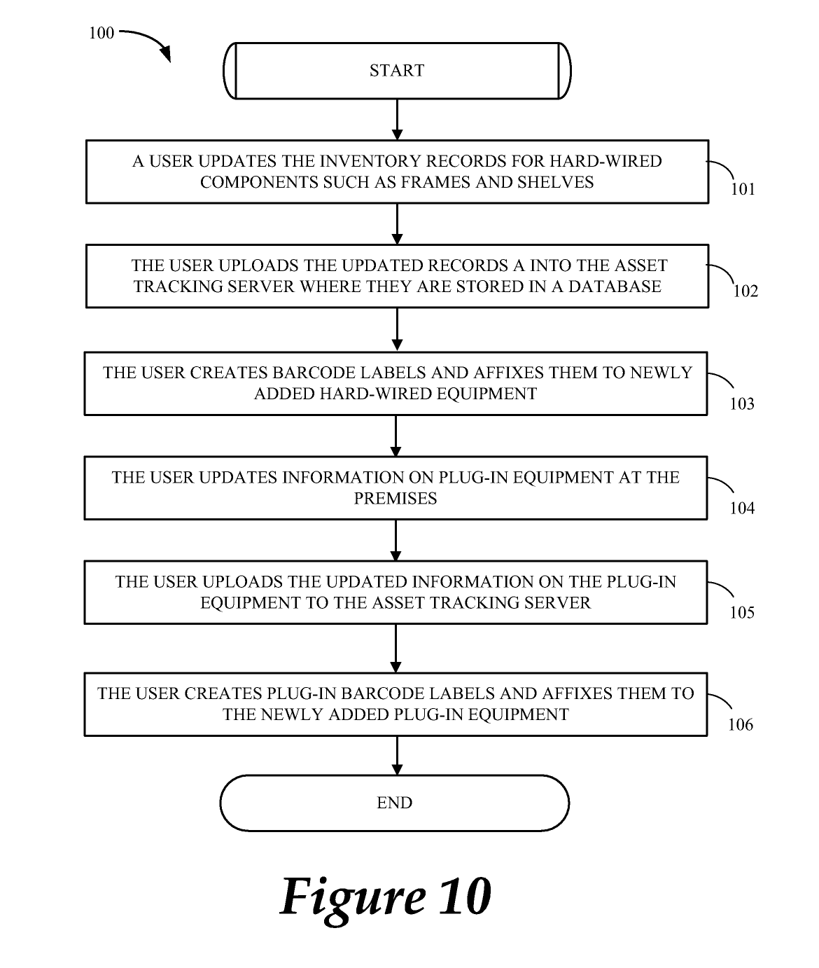

FIG. 10 is a flow chart illustrating an incremental inventory method 100, in accordance with exemplary embodiments. The incremental inventory method 100 may be implemented following completion of the initial inventory method 90. The objective of an incremental or subsequent inventory process is to ensure that asset records in an asset tracking system database are accurate and account for inventory changes. Inventory changes may occur due to purchasing, retiring, and/or transferring equipment.

As indicated in block 101, a user updates the inventory records for hard-wired components, such as frames and shelves. The records may be updated with, for example, information corresponding to newly added frames and/or shelves. The information may include, for example, one or more serial numbers or codes, as well as information describing the hard-wired components and identifying their locations.

After the user updates the inventory records for the hard-wired components, the user uploads the updated records into the asset tracking server 14, where they are stored in a database, as indicated in block 102. For example, after information for hard-wired equipment is collected, the user places the asset tracking device 13 in its docking station and the information is uploaded to the asset tracking server 14.

After uploading the data related to hard-wired equipment, the user creates barcode labels and affixes them to newly added hard-wired equipment, as indicated in block 103. Scannable barcode label images may be produced by barcode software and then printed via a barcode printer. After the labels are printed, they are affixed to the respective hard-wired equipment, such as, for example, frames and/or shelves.

After barcodes labels are affixed to corresponding hard-wired equipment, the user updates information on plug-in equipment at one or more of the premises 15a-15f, as indicated in block 104. The records may be updated with, for example, information corresponding to newly added equipment. The updated information may include, for example, one or more serial numbers or codes, as well as information describing the newly added equipment. The data may be collected by scanning barcodes on the plug-in equipment and/or entering data via a user input device, such as a mouse and/or a keyboard.

As indicated in block 105, the user uploads the updated information on the plug-in equipment to the asset tracking server 14. After the updated information is collected, the user connects the asset tracking device 13 to a docking station and the information is uploaded to the asset tracking server 14. The asset tracking device 13 may be connected to a docking station via a wired or wireless connection.

After plug-in data for one or more of the premises 15a-15f has been uploaded, the user creates barcode labels and affixes them to the newly added plug-in equipment, as indicated in block 106. Scannable barcode labels may be produced by a barcode software application and then printed via a barcode label printer. After the barcode labels are printed, each label is affixed to a corresponding piece of equipment.

Note that methods depicted in the exemplary flow charts described above may be modified to include fewer, additional, and/or different steps within the scope of this disclosure. Furthermore, steps depicted in the flow charts may be performed out of the order shown including substantially concurrently, in reverse order, or in a substantially different order.

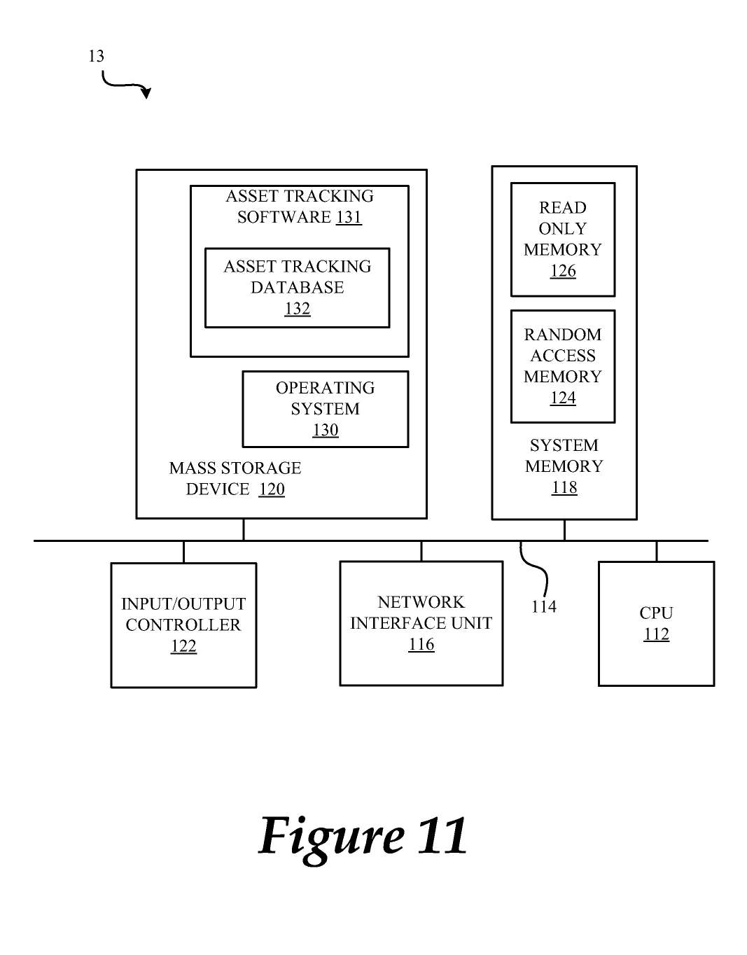

FIG. 11 is a block diagram illustrating the asset tracking device 13, in accordance with exemplary embodiments. The asset tracking device 13 includes a central processing unit (CPU) 112, a system memory 118, including a random access memory (RAM) 124 and a read-only memory (ROM) 126, and a system bus 114 that couples the memory 118 to the CPU 112. A basic input/output system containing the basic routines that help to transfer information between elements within the asset tracking device 13, such as during startup, is stored in the ROM 126. The asset tracking device 13 further includes a mass storage device 120 for storing an operating system 130 and other program modules, which will be described in greater detail below.

The mass storage device 120 is connected to the CPU 112 through a mass storage controller (not shown) connected to the bus 114. The mass storage device 120 and its associated computer-readable media provide non-volatile storage for the asset tracking device 13. Although the description of computer-readable media contained herein refers to a mass storage device, such as a hard disk or CD-ROM drive, it should be appreciated by those skilled in the art that computer-readable media can be any available media that can be accessed by the asset tracking device 13.

By way of example, and not limitation, computer-readable media may include volatile and non-volatile, removable and non-removable media implemented in any method or technology for storage of information, such as computer-readable instructions, data structures, program modules or other data. For example, computer-readable media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium which can be used to store the desired information and which can be accessed by the asset tracking device 13.

The asset tracking device 13 may connect to a network through a network interface unit 116 connected to the bus 114. It should be appreciated that the network interface unit 116 may also be utilized to connect to other types of networks and remote computer systems. The asset tracking device 13 may also include an input/output controller 122 for receiving and processing input from a number of other devices, including a keyboard, mouse, barcode scanner 16, and/or electronic stylus (not shown in FIG. 11). Similarly, an input/output controller may provide output to a display screen, a printer, or other type of output device.

A number of program modules and data files may be stored in the mass storage device 120 and RAM 124 of the asset tracking device 13, including the operating system 130 suitable for controlling the operation of the asset tracking device 13. The mass storage device 120 and RAM 124 may also store one or more program modules. In particular, the mass storage device 120 and the RAM 124 may store asset tracking software 131 configured to receive information from and provide information to users regarding company assets, such as telecommunication equipment located at central offices. The asset tracking software 131 may provide the user interface windows 20, 30, 40, 50, 60 shown in FIGS. 2-6 to enable a user to view and/or update information regarding a certain piece of equipment located at one of the premises 15.

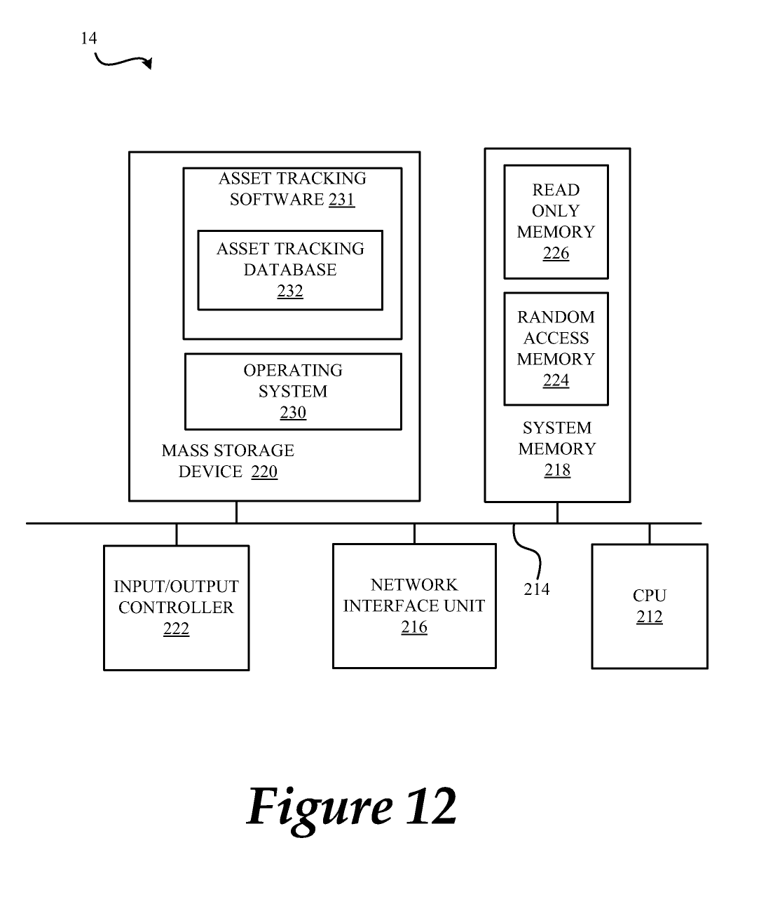

The asset tracking information provided by the asset tracking software 131 may identify the assets and their respective locations. The asset tracking information may be stored in an asset tracking database 132. The asset tracking device 13 synchronizes the asset tracking database 132 with an asset tracking database 232 (FIG. 12) of the asset tracking server 14. The synchronization of the databases 132 and 232 may take place at predetermined times and/or responsive to user input.

FIG. 12 is a block diagram illustrating the asset tracking server 14, in accordance with exemplary embodiments. The asset tracking server 14 includes a central processing unit (CPU) 212, a system memory 218, including a random access memory (RAM) 224 and a read-only memory (ROM) 226, and a system bus 214 that couples the memory 218 to the CPU 212. A basic input/output system containing the basic routines that help to transfer information between elements within the asset tracking server 14, such as during startup, is stored in the ROM 226. The asset tracking server 14 further includes a mass storage device 220 for storing an operating system 230 and other program modules, which will be described in greater detail below.

The mass storage device 220 is connected to the CPU 212 through a mass storage controller (not shown) connected to the bus 214. The mass storage device 220 and its associated computer-readable media provide non-volatile storage for the asset tracking server 14. Although the description of computer-readable media contained herein refers to a mass storage device, such as a hard disk or CD-ROM drive, it should be appreciated by those skilled in the art that computer-readable media can be any available media that can be accessed by the asset tracking server 14.

By way of example, and not limitation, computer-readable media may include volatile and non-volatile, removable and non-removable media implemented in any method or technology for storage of information, such as computer-readable instructions, data structures, program modules or other data. For example, computer-readable media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium which can be used to store the desired information and which can be accessed by the asset tracking server 14.

The asset tracking server 14 may connect to a network through a network interface unit 216 connected to the bus 214. It should be appreciated that the network interface unit 216 may also be utilized to connect to other types of networks and remote computer systems. The asset tracking server 14 may also include an input/output controller 222 for receiving and processing input from a number of other devices, including a keyboard, mouse, scanner 16, or electronic stylus (not shown in FIG. 12). Similarly, an input/output controller may provide output to a display screen, a speaker, a printer, or other type of output device.

A number of program modules and data files may be stored in the mass storage device 220 and RAM 224 of the asset tracking server 14, including the operating system 230 suitable for controlling the operation of the asset tracking server 14. The mass storage device 220 and RAM 224 may also store one or more program modules. In particular, the mass storage device 220 and the RAM 224 may store asset tracking software 231 configured to receive asset tracking information from the asset tracking devices 13 located at respective premises, such as the premises 15. The received asset tracking information identifies assets and their respective locations. The asset tracking software 231 stores the received asset tracking information in the asset tracking database 232. The asset tracking software 231 then makes the asset tracking information received from the asset tracking device 13 available to the other asset tracking devices 13.

Although the subject matter presented herein has been described in conjunction with one or more particular embodiments and implementations, it is to be understood that the embodiments defined in the appended claims are not necessarily limited to the specific structure, configuration, or functionality described herein. Rather, the specific structure, configuration, and functionality are disclosed as example forms of implementing the claims. Various modifications and changes may be made to the subject matter described herein without following the example embodiments and applications illustrated and described, and without departing from the true spirit and scope of the embodiments, which is set forth in the following claims.

What is claimed is:

1. A computer-implemented method for tracking assets, comprising:
providing selectable options corresponding to respective premises;
receiving a first input selecting an option corresponding to a first premises;
responsive to receiving the first input, providing selectable options corresponding to aisles within the first premises;
receiving a second input selecting an option corresponding to a first aisle within the first premises;
responsive to receiving the second input, providing selectable options corresponding to frames located along the first aisle;
receiving a third input selecting an option corresponding to a first frame located along the first aisle;
responsive to receiving the third input, providing selectable options corresponding to shelves within the first frame;
receiving a fourth input selecting an option corresponding to a first shelf supported by the first frame;
responsive to receiving the fourth input, providing selectable options corresponding to at least one of assets and asset locations corresponding to the first shelf; and
receiving a fifth input selecting an option corresponding to at least one of the assets and the asset locations.

2. The method of claim 1, further comprising:
responsive to receiving the fifth input, providing a user interface for enabling a user to provide information about a first asset corresponding to at least one of the assets and the asset locations; and
receiving a sixth input identifying information corresponding to the first asset, the sixth input provided via the user interface.

3. The method of claim 1, further comprising responsive to receiving the fifth input, providing information about an asset corresponding to at least one of the assets and the asset locations, wherein the information identifies at least a location of the asset.

4. The method of claim 1, further comprising attaching to an asset corresponding to the first shelf a scannable barcode label identifying the first shelf.

5. The method of claim 4, further comprising receiving input via a scanner responsive to a user scanning the barcode label.

6. The method of claim 5, further comprising providing information corresponding to the asset responsive to receiving the input via the scanner.

7. The method of claim 6, wherein the information identifies the asset and a location of the asset.

8. The method of claim 4, wherein the asset is a telecommunication device located at the premises is a central office.

9. The method of claim 1, further comprising providing information about an asset corresponding to the first shelf to a remote server.

10. The method of claim 9, further comprising receiving from the remote server information corresponding to a plurality of assets located at a plurality of respective premises, wherein the information corresponding to the plurality of assets is received from a plurality of respective computing devices located at the plurality of respective premises.

11. A system for tracking assets, comprising:
a processor; and
memory comprising instructions configured to enable the processor to:
provide selectable options corresponding to respective premises;
receive a first input selecting an option corresponding to a first premises;
responsive to receiving the first input, provide selectable options corresponding to aisles within the first premises;
receive a second input selecting an option corresponding to a first aisle within the first premises;
responsive to receiving the second input, provide selectable options corresponding to frames located along the first aisle;
receive a third input selecting an option corresponding to a first frame located along the first aisle;
responsive to receiving the third input, provide selectable options corresponding to shelves within the first frame;
receive a fourth input selecting an option corresponding to a first shelf supported by the first frame;
responsive to receiving the fourth input, provide selectable options corresponding to at least one of assets and asset locations corresponding to the first shelf; and
receive a fifth input selecting an option corresponding to at least one of the assets and the asset locations.

12. The system of claim 11, wherein the instructions are further configured to enable the processor to:
responsive to receiving the fifth input, provide a user interface for enabling a user to provide information about a first asset corresponding to at least one of the assets and the asset locations; and
receive a sixth input identifying information corresponding to the first asset, the sixth input provided via the user interface.

13. The system of claim 11, wherein the instructions are further configured to enable the processor to, responsive to receiving the fifth input, provide the user with information about an asset corresponding to at least one of the assets and the asset locations, wherein the information identifies at least a location of the asset.

14. The system of claim 11, wherein the instructions are further configured to enable the processor to:
receive input via a scanner responsive to a user scanning a barcode label attached to an asset corresponding to the first shelf; and
provide information corresponding to the asset responsive to receiving the input via the scanner.

15. The system of claim 14, wherein the information identifies the asset and a location of the asset.

16. A computer readable storage medium for tracking assets, comprising:
instructions configured to enable a computer to:
provide selectable options corresponding to respective premises;
receive a first input selecting an option corresponding to a first premises;
responsive to receiving the first input, provide selectable options corresponding to aisles within the first premises;
receive a second input selecting an option corresponding to a first aisle within the premises;
responsive to receiving the second input, provide selectable options corresponding to frames located along the first aisle;
receive a third input selecting an option corresponding to a first frame located along the first aisle;
responsive to receiving the third input, provide selectable options corresponding to shelves within the first frame;
receive a fourth input selecting an option corresponding to a first shelf supported by the first frame; and
responsive to receiving the fourth input, provide selectable options corresponding to at least one of assets and asset locations corresponding to the first shelf;
receive a fifth input selecting an option corresponding to at least one of the assets and the asset locations.

17. The computer readable storage medium of claim 16, wherein the instructions are further configured to enable the computer to:
responsive to receiving the fifth input, provide a user interface for enabling a user to provide information about a first asset corresponding to at least one of the assets and the asset locations; and
receive a sixth input identifying information corresponding to the first asset, the sixth input provided via the user interface.

18. The computer readable storage medium of claim 16, wherein the instructions are further configured to enable the computer to, responsive to receiving the fifth input, provide the user with information about an asset corresponding to at least one of the assets and the asset locations, wherein the information identifies at least a location of the asset.

19. The computer readable storage medium of claim 16, wherein the instructions are further configured to enable the computer to:
receive input via a scanner responsive to a user scanning a barcode label attached to an asset corresponding to the first shelf; and
provide information corresponding to the asset responsive to receiving the input via the scanner.

20. The computer readable storage medium of claim 19, wherein the information identifies the asset and a location of the asset.
